(19) United States
(12) Patent Application Publication
(10) Pub. No.: US 2012/0291950 A1
(43) Pub. Date: Nov. 22, 2012

(54) MOUNTING METHOD AND MOUNTING DEVICE

(75) Inventors: Masahiko Sugiyama, Nirasaki City (JP); Michikazu Nakamura, Nirasaki City (JP); Dai Shinozaki, Nirasaki City (JP); Naoki Akiyama, Nirasaki City (JP)

(73) Assignee: TOKYO ELECTRON LIMITED, Tokyo (JP)

(21) Appl. No.: 13/519,237

(22) PCT Filed: Dec. 24, 2010
(86) PCT No.: PCT/JP2010/073354

§ 371 Date: Jun. 26, 2012

(30) Foreign Application Priority Data
Dec. 28, 2009 (JP) 2009-297627

(51) Int. Cl. B32B 38/00; B32B 38/18

(52) U.S. Cl. 156/285; 156/60; 156/556

(57) ABSTRACT

A mounting method of mounting an element on a substrate, includes a first hydrophilization process of hydrophilizing a region on a surface of the substrate where the element is to be joined; a second hydrophilization process of hydrophilizing the surface of the element; a mounting process of mounting the element on a mounting part such that the hydrophilized surface of the element faces upwards; a coating process of coating a liquid on the hydrophilized surface of the element; and an arrangement process of arranging the substrate above the mounting part such that the region on the surface of the substrate where the element is to be joined faces downwards. The method further includes a contact process of bringing the substrate arranged above the mounting part close to the mounting part on which the element is mounted to bring the liquid into contact with the surface of the substrate.

### FIELD OF THE INVENTION

The present invention relates to a mounting method and a mounting device for mounting an element on a substrate.

### BACKGROUND OF THE INVENTION

Recently, a three-dimensional (3D) mounting technique draws attention as semiconductor integration technology. According to the 3D mounting technique, a substrate with an integrated circuit formed thereon in advance is separated into individual pieces called dies, and known good dies (KGDs), which are determined to be good through a quality test conducted before the separation into individual pieces, are selected from the dies. Then, the selected dies are deposited and mounted on a selected substrate.

For example, a mounting method of mounting the dies (hereinafter, referred to as “chips” or “elements”) on a substrate is disclosed in International Patent Application Publication No. 2006/077739 (WO2006/077739A). In this mounting method, a tray for collectively mounting chips is employed.

As described above, semiconductor chips in a group selected as good chips through the quality test are collectively mounted on chip mounting regions of the tray. After mounting chips on all the chip mounting regions, the chips are vacuum-adsorbed and held on the tray by vacuum suction through holes formed in the bottom portions of the chip mounting regions using a vacuum pump. Then, the tray is turned over while maintaining the vacuum adsorption of the chips in the group and moved over a carrier substrate on contact regions of which water is held. The vacuum adsorption is released so that the respective chips are dropped from the tray onto the carrier substrate at the same time. The chips dropped on the carrier substrate voluntarily move to the contact regions on the carrier substrate under the action of the surface tension of water, thus achieving alignment.

However, according to the method disclosed in WO2006/077739A, chips may not be securely mounted on a substrate if an error is made in the vacuum adsorption due to any factor, e.g., even a warpage or crack for even one chip among the chips collectively mounted on the tray. If an error is made in the vacuum adsorption for even one chip, the vacuum adsorbing force of the respective chips may be decreased, so that all the chips may drop when the tray is turned over.

In order to prevent the chips from dropping, a mounting method of controlling vacuum exhaustion in each chip mounting region is considered. However, a tray is required to have a complicated structure for controlling vacuum exhaustion in each chip mounting region. Also, since the size, layout, or number of chips is varied depending on products, it is difficult to use a single common tray and several trays may be needed. As such, a tray involves a complicated structure or several trays are needed to prevent chips from dropping, causing an increase in device costs.

### SUMMARY OF THE INVENTION

In view of the above, the present invention provides a mounting method and a mounting device which can securely mount an element, such as a chip, on a substrate without involving an increase in device costs.

To solve the foregoing problems, the present invention provides exemplary embodiments as follows.

In accordance with an aspect of the present invention, there is provided a mounting method of mounting an element on a substrate, including a first hydrophilization process of hydrophilizing a region on a surface of the substrate where the element is to be joined; a second hydrophilization process of hydrophilizing the surface of the element; a mounting process of mounting the element on a mounting part in such a manner that the hydrophilized surface of the element faces upwards; a first coating process of coating a liquid on the hydrophilized surface of the element; an arrangement process of arranging the substrate above the mounting part in such a manner that the region on the surface of the substrate where the element is to be joined faces downwards; and a contact process of bringing the substrate arranged above the mounting part and the mounting part on which the element is mounted close to each other to bring the liquid and the surface of the substrate into contact with each other. In accordance with another aspect of the present invention, there is provided a mounting device for mounting an element on a substrate, including a mounting part on which an element is mounted, the element being prepared by hydrophilizing the surface of the element and coating a liquid on the hydrophilized surface of the element, in such a way that the hydrophilized surface faces upwards; a substrate holding unit disposed above the mounting part, the substrate holding unit serving to hold a substrate, the substrate being prepared by hydrophilizing a region on the surface of the substrate where the element is to be joined, in such a way that the region where the element is to be joined faces downwards; and a control stage configured to move at least one of the substrate holding unit and the mounting part to bring the substrate holding unit holding the substrate and the mounting part on which the element is mounted close to each other, thereby bringing the liquid and the surface of the substrate into contact with each other. As described above, in accordance with the mounting method and the mounting device it is possible to securely mount an element, such as a chip, on a substrate without involving an increase in device costs.

### BRIEF DESCRIPTION OF THE DRAWINGS

The objects and features of the present invention will become apparent from the following description of embodiments, given in conjunction with the accompanying drawings, in which:

FIG. 1 is a schematic cross-sectional view illustrating a configuration of a mounting device in accordance with a first embodiment of the present invention;

FIG. 2 is a flowchart illustrating the processes of a mounting method in accordance with the first embodiment of the present invention;

FIGS. 3A to 3J are schematic cross-sectional views illustrating the states of chips and a substrate in each process of the mounting method in accordance with the first embodiment of the present invention;

FIG. 4 is a plan view illustrating the state of the respective chips held in predetermined positions on a tray;

FIGS. 5 and 6 are schematic cross-sectional views illustrating the states of the chips and the substrate in the mounting apparatus in each process of the mounting method in accordance with the first embodiment of the present invention;

FIGS. 7A and 7B are schematic cross-sectional views illustrating the states of the chips and the substrate when the chips are transferred (mounted and moved) from a first substrate to a second substrate;

FIGS. 8A to 8D illustrate plan views and cross-sectional views showing how the state of a chip is changed from the state of being brought into contact with the surface of water while being obliquely misaligned with the contact regions to the state of being mounted on proper positions by self-alignment;

FIGS. 9A to 9D show illustrates plan views and cross-sectional views showing how the state of the chip is changed from the state of being brought into contact with the surface of water while being horizontally misaligned with the contact regions to the state of being mounted on proper positions by self-alignment;

FIGS. 10A and 10B are plan views each illustrating a hydrophilized region on the surface of the chips;

FIG. 11 is a flowchart illustrating the processes of a mounting method in accordance with a modification of the first embodiment;

FIGS. 12A to 12K are schematic cross-sectional views illustrating the states of chips and a substrate in each process of the mounting method in accordance with the modification of the first embodiment;

FIG. 13 is a schematic cross-sectional view illustrating a configuration of a mounting device in accordance with a second embodiment of the present invention.

FIG. 14 is a flowchart illustrating the processes of a mounting method in accordance with the second embodiment of the present invention; and

FIGS. 15A to 15K are schematic cross-sectional views illustrating the states of chips and a substrate in each process of the mounting method in accordance with the second embodiment of the present invention.

### DETAILED DESCRIPTION OF THE EMBODIMENTS

Embodiments of the present invention will now be described with reference to the accompanying drawings.

### First Embodiment

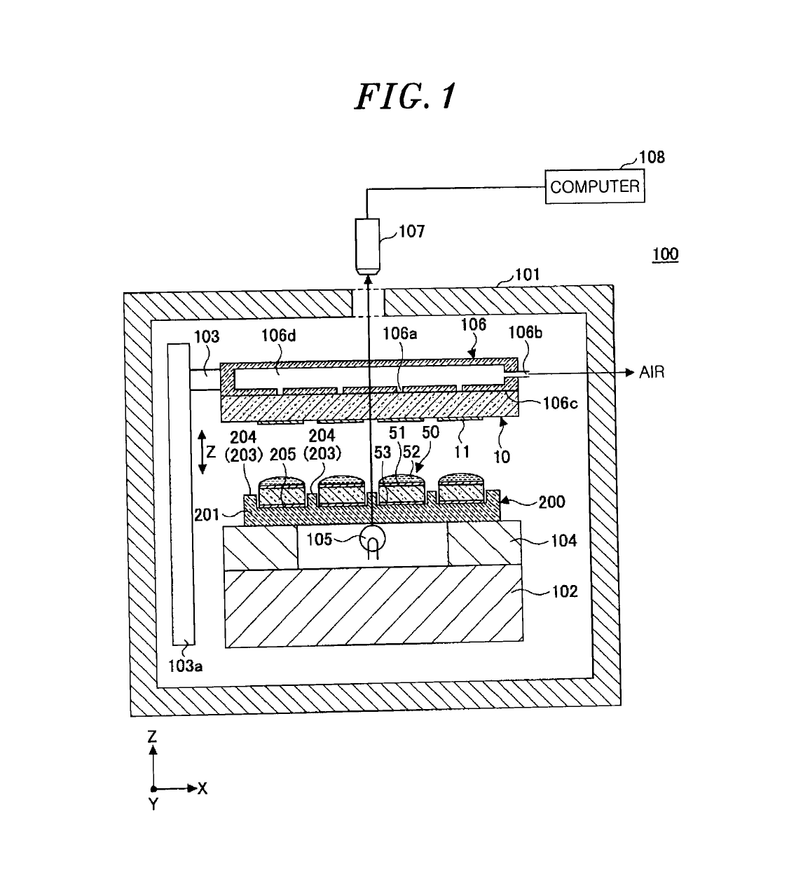

A mounting method and a mounting device in accordance with a first embodiment will be described with reference to FIGS. 1 to 10B.

First, the mounting device is described with reference to FIG. 1. FIG. 1 is a schematic cross-sectional view illustrating a configuration of the mounting device in accordance with the first embodiment.

As shown in FIG. 1, the mounting device 100 includes a processing chamber 101; a control stage 102; a control arm 103; a support base 104; an infrared lamp 105; a vacuum chuck 106; a CCD camera 107; and a computer 108. Further, the mounting device 100 includes a loading/unloading port (not shown) and a carrier (not shown) for carrying a substrate and a tray.

The processing chamber 101 is provided to surround the control stage 102, the control arm 103, the support base 104, the infrared lamp 105 and the vacuum chuck 106 in such a way that the internal atmosphere thereof can be controlled, e.g., depressurized. The processing chamber 101 is connected to a supply unit (not shown) for introducing a gas, such as a clean air or nitrogen gas having adjusted temperature and humidity, and to a pump (not shown) for exhausting the inside of the processing chamber, so that the pressure in the processing chamber 101 is adjusted depending on the type of processing.

The control stage 102 is configured to make a translational motion in two directions (X and Y directions) perpendicular to each other on the horizontal plane (including left and right directions and being perpendicular to the plane of the paper of FIG. 1) and in the vertical direction (Z direction) perpendicular to the horizontal plane, and making a rotary motion (at an angle of θ) on the horizontal plane. That is, the control stage 102 can be controlled on four axes, X, Y, Z, and θ axes. The control stage 102 has two operation (control) modes, which are a rough operation mode and a fine operation mode, and can switch between the two modes as needed. Typically, the control stage 102 is roughly aligned in the rough operation mode and then accurately aligned in the fine operation mode.

The control arm 103 is configured to make a translational motion along a rail 103a formed in the vertical direction (Z direction) perpendicular to the horizontal plane. Further, the control arm 103 is configured to make a translational motion in the two directions (X and Y directions) perpendicular to each other on the horizontal plane and a rotary motion (at an angle of θ) on the horizontal plane. That is, the control arm 103 can be controlled on four axes, the X, Y, Z, and θ axes. The control arm 103 also has two operation (control) modes, a rough operation mode and a fine operation mode, and can switch between the two modes as needed. Typically, the control arm 103 is roughly aligned in the rough operation mode and then accurately aligned in the fine operation mode.

Each of the control stage 102 and the control arm 103 serve as a control stage in the present invention. Here, it is preferable that the relative position between the control stage 102 and the control arm 103 can be controlled on the X, Y, Z, and θ axes. Therefore, only any one of the control stage 102 and the control arm 103 may be provided in such a way as to be controlled on the X, Y, Z, and θ axes.

The support base 104 is fixed to an upper surface (mounting surface) of the control stage 102. The support base 104 includes a hollow portion provided nearly in the center, and the infrared lamp 105 used as a light source is installed in the hollow portion.

The upper surface of the support base 104 serves as a tray supporting unit which supports a tray 200 for collectively mounting chips thereon. The tray supporting unit (support base) 104 supports the tray 200 horizontally by fixing the tray 200 using a proper tool (e.g., a screw and a hook).

The chips serve as elements in the present invention. The tray supported by the support base serves as a mounting part in the present invention.

The tray 200 includes a main body 201 having a rectangular plane shape. The surface of an upper wall 203 of the main body 201 is partitioned by partition walls 204 into rectangular sections, the rectangular sections serving as chip mounting regions 205 in which chips 50 are mounted. The tray 200 is formed of a material, e.g., quartz or transparent plastic, through which infrared lights emitted from the infrared lamp 105 are transmitted, the transparent plastic being manufactured with a lower cost.

The vacuum chuck 106 is provided immediately above the tray 200 supported by the tray supporting unit (support base) 104 to maintain the substrate 10 horizontally. The vacuum chuck 106 includes a hollow inside, a bottom with small holes 106a, and one end portion with a hole 106b. The vacuum chuck 106 further includes a holding surface 106c for holding the substrate 10 at the bottom.

The substrate 10 can be fixed and maintained to the holding surface 106c by vacuum adsorption, that is, by ejecting air in the inner space 106d through the input and output hole 106b to create a desirable vacuum state in a state that the substrate 10 is pressed against the holding surface 106c. Alternatively, the vacuum chuck 106 may be provided to be turned upside down. In this case, the substrate 10 is mounted on the holding surface 106c of the vacuum chuck 106 which faces upwards and is then vacuum-adsorbed and securely fixed to the holding surface 106c by exhausting the inner space 106d to vacuum. Thereafter, the vacuum chuck 106 is turned over.

Meanwhile, the substrate 10 can be released from the holding surface 106c by introducing air into the inner space 106d through the input and output hole 106b to relieve the vacuum state. The vacuum chuck 106 is formed of a material (e.g., quartz and transparent plastic, manufactured with a lower cost) through which infrared lights emitted from the infrared lamp 105 are transmitted.

The vacuum chuck 106 serves as a substrate holding unit in the present invention. Instead of the vacuum chuck 106, a chuck capable of turning upside down and holding a substrate by using electrostatic adsorption may be provided.

As shown in FIG. 1, when the chips 50 are mounted in the chip mounting regions 205 of the tray 200 and the substrate 10 is held on the vacuum chuck 106, there is a proper interval between the chips 50 on the tray 200 and the substrate 10 on the vacuum chuck 106. The interval between the chips 50 and the substrate 10 may be increased or decreased by the control stage 102 and the control arm 103.

The CCD camera (in which a charged-coupled device is used for a sensor) 107 is provided above the support base (tray supporting unit) 104 outside the processing chamber 107, in such a way as to be positioned nearly directly above the infrared lamp 105. The CCD camera 107, which is an imaging device for detecting infrared lights emitted from the infrared lamp 105, converts detected infrared lights into an electrical signal to transmit the signal to the computer 108 that is an operation device and performs predetermined data processing. As such, by using the CCD camera 107 and the relevant units, contact regions 11 on the substrate 10 held by the vacuum chuck 106 are matched with the chips 50 mounted on the tray 200 one to one at a predetermined accuracy. That is, by using the CCD camera 107 and the relevant units, the substrate 10 on the vacuum chuck 106 is aligned with the tray 200 supporting the chips 50.

The control stage 102 (or the control arm 103), the infrared lamp 105, the CCD camera 107, and the computer 108 constitutes a position alignment mechanism in the present invention.

To facilitate such position alignment, alignment marks (not shown) are formed on the chips 50 or the tray 200 and the substrate 10, respectively. The CCD camera 107 detects the alignment marks, and the position of the control stage 102 is minutely adjusted and fixed in such a way that the alignment marks of the chips 50 or tray 200 properly correspond to the alignment marks of the substrate 10. Accordingly, the contact regions 11 on the substrate 10 and the chips 50 mounted on the tray 200 can be matched with each other one to one.

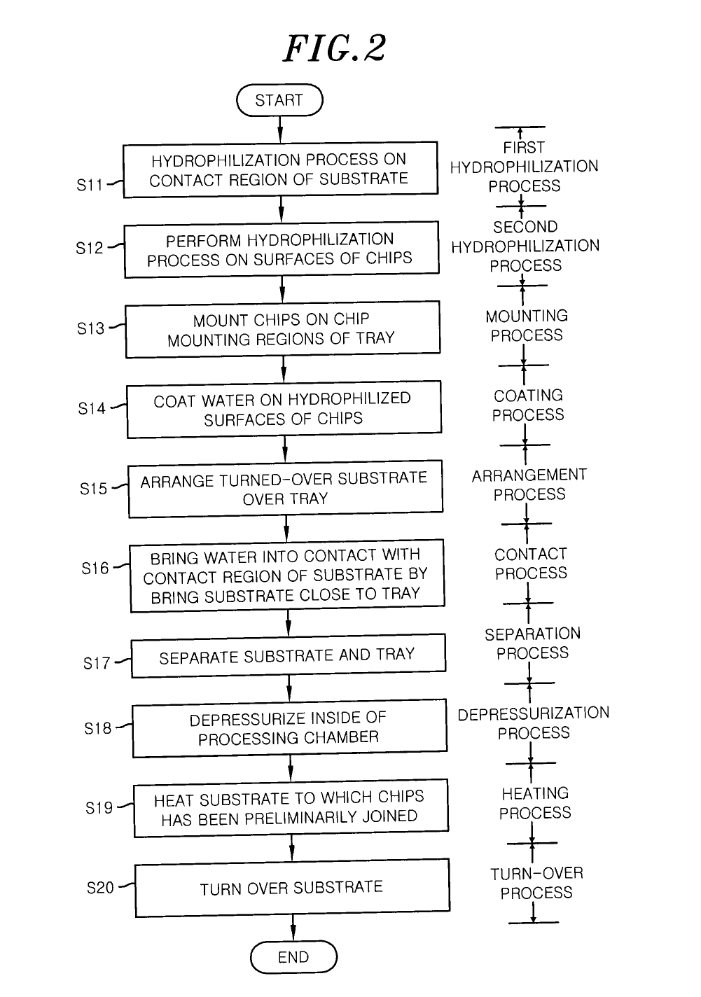

Next, the mounting method in the mounting device in accordance with the first embodiment will be described with reference to FIGS. 2 to 7B.

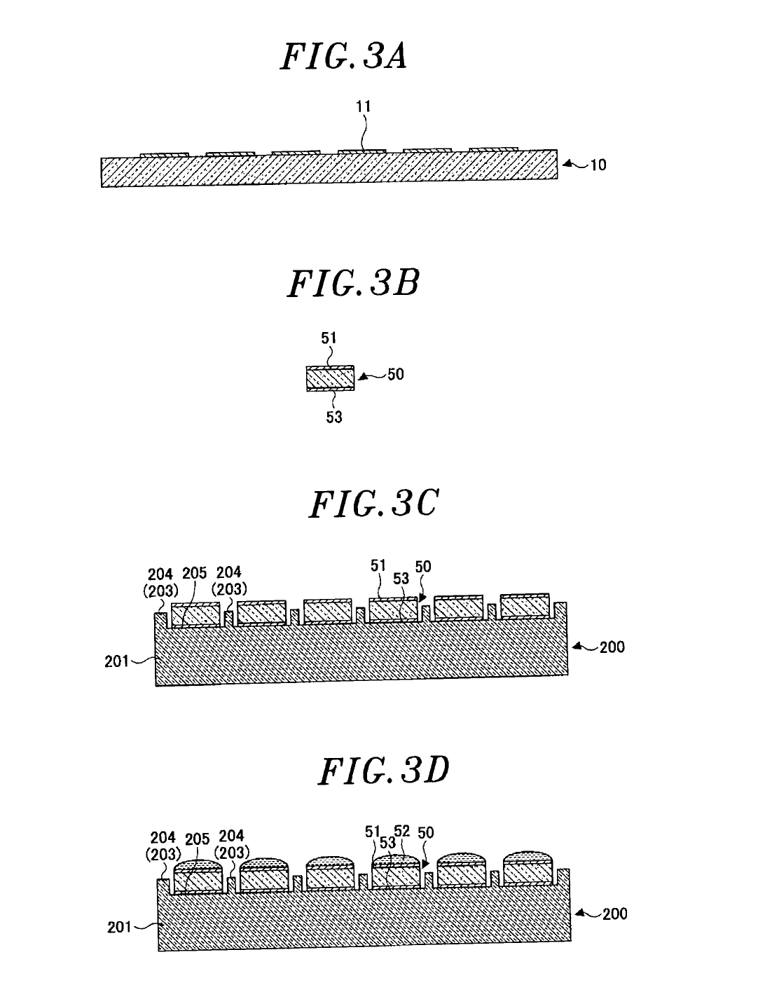

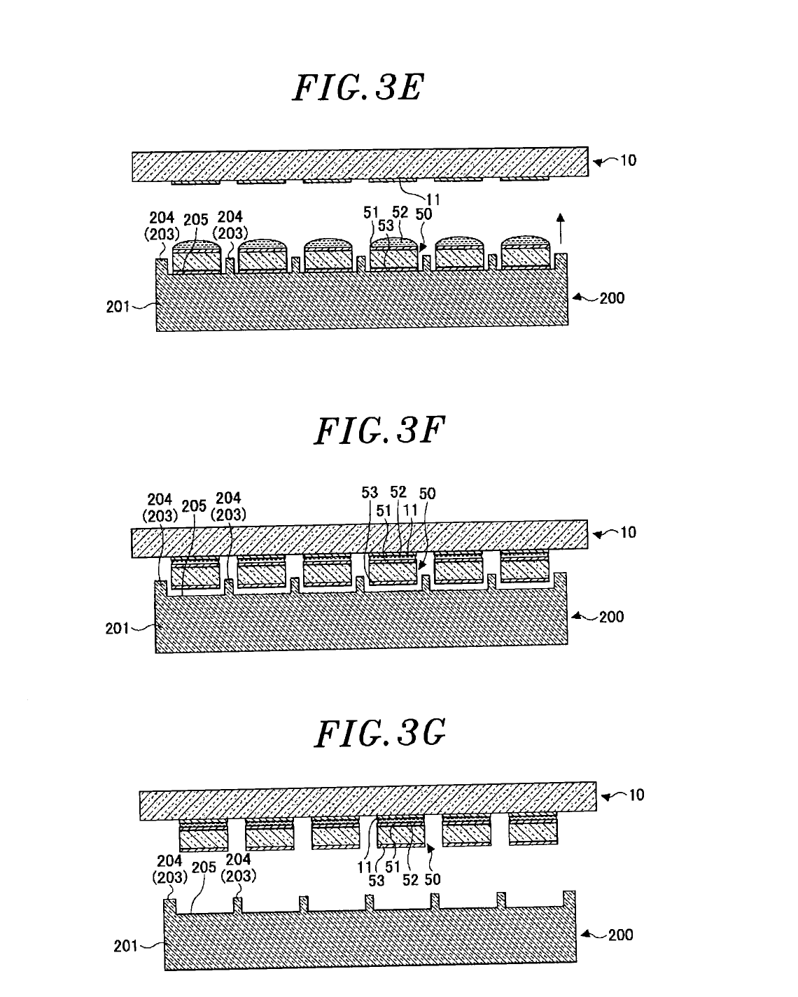

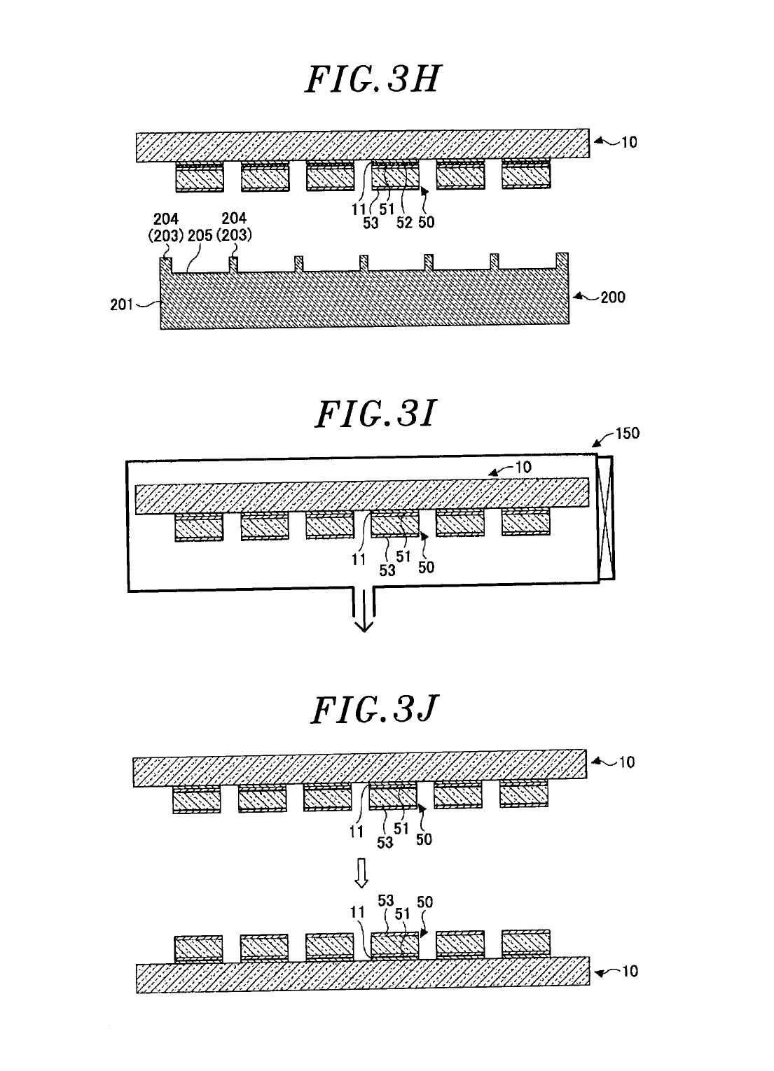

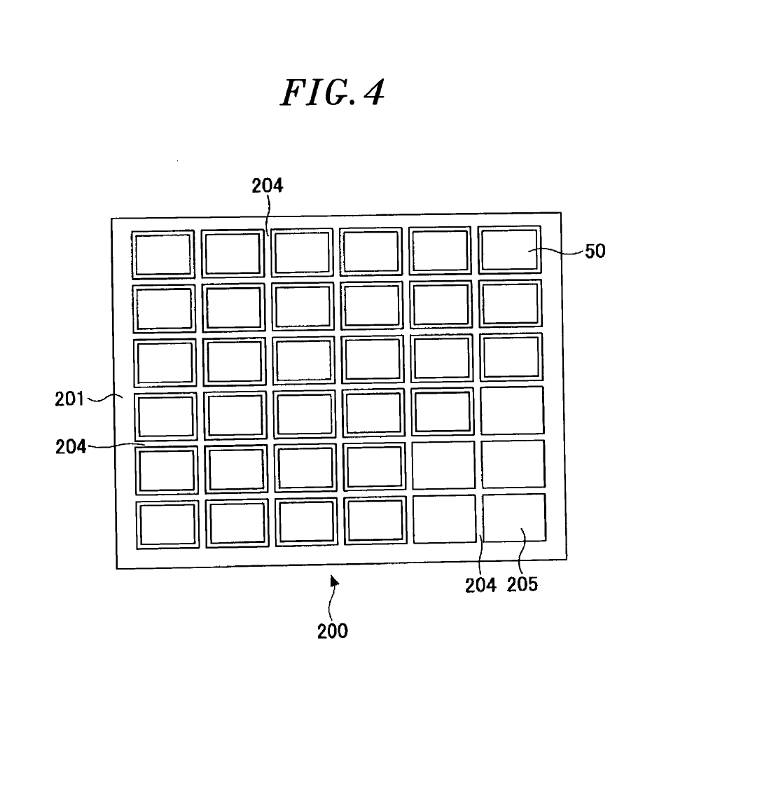

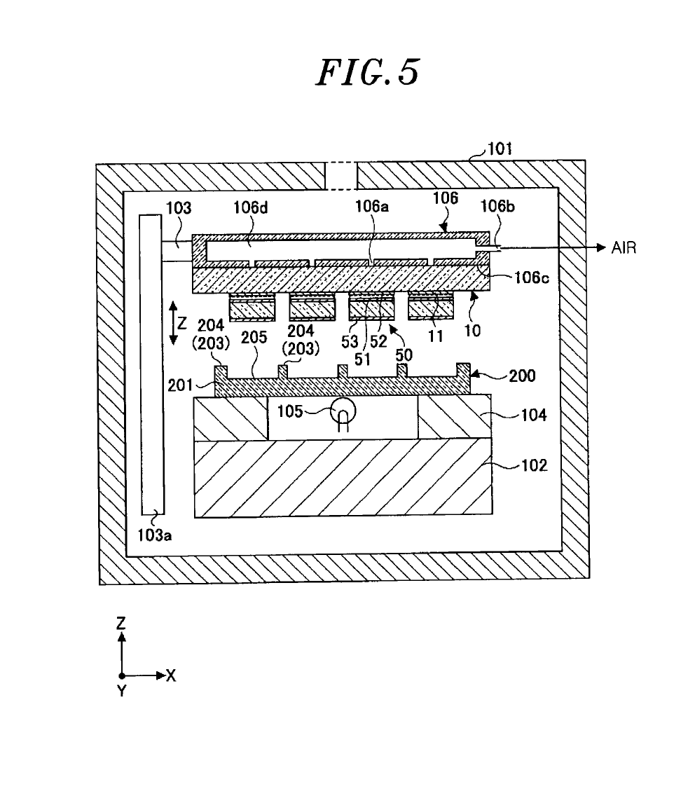

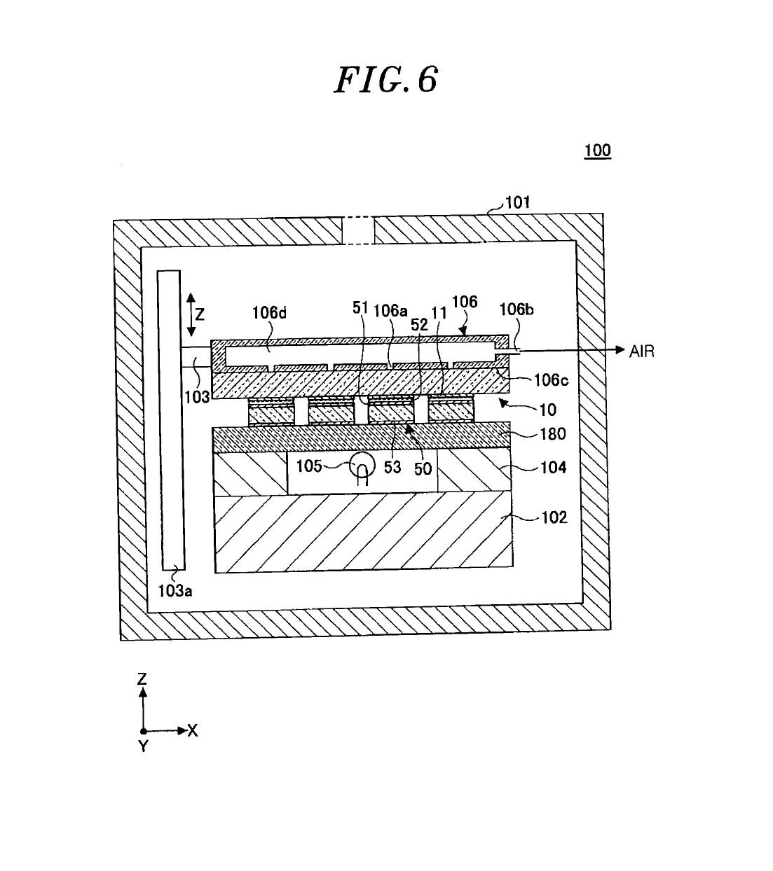

FIG. 2 is a flowchart illustrating the processes of the mounting method in accordance with the first embodiment. FIGS. 3A to 3J are schematic cross-sectional views illustrating the states of chips and the substrate in the respective processes of the mounting method in accordance with the first embodiment. FIG. 4 is a plan view illustrating the state of chips held in predetermined positions of the tray. FIGS. 5 and 6 are schematic cross-sectional views illustrating the state of the chips and the substrate in the mounting apparatus in the respective processes of the mounting method in accordance with the first embodiment.

Referring to FIGS. 2A to 2J, the mounting method in accordance with the present embodiment includes a first hydrophilization process (step S11), a second hydrophilization process (step S12), a mounting process (step S13), a coating process (step S14), an arrangement process (step S15), a contact process (step S16), a separation process (step S17), a depressurization process (step S18), a heating process (step S19), and a turn-over process (step S20).

First, the first hydrophilization process is carried out in step S11. In step S11, the contact regions 11 on the surface of the substrate 10 where the chips are to be joined are hydrophilized. FIG. 3A shows the state of the substrate 10 in step S11.

First, there is prepared a substrate 10 which has an enough size for a needed number of chips 50, e.g., semiconductor chips, to be mounted in a desired layout and has a hardness sufficient to endure the weight of the needed number of the chips 50. For example, a glass substrate and a semiconductor wafer which have a sufficient hardness may be used as the substrate 10.

As shown in FIG. 3A, contact regions 11 having the shape of a rectangular thin film are formed on one surface of the substrate 10, wherein the same number of contact regions as the total number of the chips 50 (FIG. 3A(a) shows six regions only) are provided. The size and shape of the contact regions 11 are substantially the same as those of the chips 50 to be mounted thereon.

In the present embodiment, since water is used as a preliminary joining material for the chips 50, the contact regions 11 are prepared to have hydrophilicity. The contact regions 11 can be easily formed by using, e.g., a silicon dioxide (SiO₂) film having hydrophilicity. That is, a SiO₂ film (e.g., 0.1 μm in thickness) is formed thin on the entire mounting surface of the substrate 10 by using a known method and then selectively removed by a known etching method, thereby readily obtaining the contact regions 11. With the hydrophilicity of the contact regions 11, if a small amount of water is loaded onto the contact regions 11, the water becomes accustomed to the entire surface of each of the contact regions 11 (i.e., the water wets the entire surface of each of the contact regions 11), thereby forming a thin water layer (water drops) 12 covering the entire surface. The contact regions 11 have an island shape and thus are isolated from each other, so that the water is not ejected out of the contact regions 11.

Available materials for the hydrophilic contact regions 11 may include Si₃N₄, a double layer of aluminum and alumina (Al/Al₂O₃), a double layer of tantalum and tantalum oxide (Ta/Ta₂O₅), and the like in addition to SiO₂.

In order to securely prevent the water from spilling out of the contact regions 11 and stagnating, the other region of the substrate 10 than the contact regions on which the chips 50 are to be mounted preferably has hydrophobicity. For example, the substrate 10 itself is preferably formed of monocrystalline silicon (Si), fluorine resin, silicone resin, Teflon (Trademark) resin, polyimide resin, resist, wax, benzocyclobutene (BCB), and the like, which are hydrophobic. Alternatively, the mounting surface of the substrate 10 on which the contact regions 11 are formed is preferably covered with polycrystalline silicon, amorphous silicon, fluorine resin, silicone resin, Teflon resin, polyimide resin, resist, wax, BCB, and the like.

Instead, selective hydrophilization is applied to the contact regions 11 by using an ink jet method or the like.

Next, the second hydrophilization process is carried out in step S12. In step S12, the surfaces of the chips 50 are hydrophilized. FIG. 3B shows the state of the chips in step S12.

As shown in FIG. 3B, a joint portion 51 having hydrophilicity is formed on one surface of each chip 50. The joint portion 51 is easily formed, for example, by covering the entire portion of the corresponding surface of each chip 50 with a SiO₂ film having hydrophilicity. Further, on the opposite surface of each of the chips 50 to the surface thereof on which the joint portion 51 is formed, a connecting member 53 for electrical connection of the corresponding chip 50 may be formed.

In the present embodiment, the substrate 10 can be a semiconductor wafer having a diameter of, e.g., 300 mm. The chips 50 can be square semiconductor chips, each side of which has a length of, e.g., 5 mm, obtained by dicing a semiconductor wafer with a diameter of, e.g., 300 mm. Further, a through electrode with a diameter of, e.g., 5 μm may be formed in the joint portions 51 of the chips 50 and the contact regions 11 of the substrate 10.

Next, the mounting process is carried out in step S13. In step S13, the chips 50 are mounted on the chip mounting regions 205 of the tray 200, the hydrophilized surfaces of the chips 50 facing upwards. FIG. 3C shows the state of the chips in step S13.

A needed number of chips 50 are mounted on the respective chip mounting regions 205 of the tray 200 in such a manner that the joint portions 51 face upwards, the chip mounting regions 205 facing upward. In this way, the respective chips 50 are mounted in predetermined positions of the tray 200. FIGS. 3C and 4 show the state of the chips in step S13 (in FIG. 4, part of the chips 50 are eliminated for easy recognition of the chip mounting regions 205).

For simple illustration, FIG. 4 shows a case where the chip mounting regions 205 are arranged in a grid pattern. However, the layout of the chips 50 on the tray 20 properly varies as necessary. Further, in the present embodiment, since the respective chips 50 are not vacuum-adsorbed to the chip mounting regions 205, it is not needed to mount the chips 50 on all the chip mounting regions 205, and the layout of the chips 50 on the tray 200 may vary randomly. Therefore, the same tray 200 can be used for different layouts of the chips 50, thus saving device costs as compared with the case of manufacturing a tray whenever needed.

The chip mounting regions 205 have a rectangular shape in the same manner as the chips 50 but are formed to be slightly larger than the external diameter of the chips 50 to facilitate the arrangement of the chips 50. Thus, gaps in a range from about 1 μm to several hundreds μm are generally formed between the chips 50 and the surrounding partition walls 204.

Next, the coating process is carried out in step S14. In step S14, a liquid is coated on the hydrophilized surfaces of the chips 50. FIG. 3D shows the state of the chips 50 in step S14.

A small amount of water is dropped on the respective joint portions 51 or all the chips 50, or the joint portions 51 are dipped in water, thereby wetting the joint portions 51 with water. Then, as shown in FIG. 3D, the water spreads to the entire surface of each of the joint portions 51 with the hydrophilicity of the joint portions 51, so that a thin water layer 52 is formed in such a way to cover the entire surface of the corresponding joint portion 51. The water layers 52 curve naturally in a gentle convex form by surface tension. The amount of water is preferably adjusted to, for example, the extent enough to form the water layers 52 on the joint portions 51 as shown in FIG. 3D

The water used in the present embodiment is preferably ultrapure water generally used in a conventional semiconductor manufacture process. More preferably, ultrapure water containing an appropriate additive for increasing the surface tension of water is used to reinforce a self-aligning function of the chips 50 with the contact regions 11 of the substrate 10. As the self-aligning function is reinforced, the positional accuracy of the chips 50 with respect to the contact regions 11 of the substrate 10 is improved. Also, as described above, silicon dioxide (SiO₂) can be preferably used as a hydrophilic material.

Instead of water, an inorganic or organic liquid may be used. For example, glycerin, acetone, alcohol, a spin on glass (SOG) material, or the like are preferably used. In this case, lyophilic materials for these liquids are needed to form the contact regions 11, and examples of such materials include silicon nitride (Si₃N₄), various kinds of metal, thiol, alkanethiol, and the like. In addition, adhesives having adequate viscosity and reducing liquids, such as formic acid, can be used as well.

Next, the arrangement process is carried out in step S15. In step S15, the substrate 10 is turned over so that the contact regions 11 on the surface of the substrate 10, in which the chips 50 are to be mounted, face downward, and the turned-over substrate 10 is disposed over the tray 200. FIG. 3E shows the state of the chips and the substrate in step S15.

FIG. 3E shows that the tray 200 carrying the predetermined number of chips 50 faces the substrate 10 to which the chips 50 are to be joined, the contact regions 11 of the substrate 10 facing downwards. As described above, the surfaces of the chips 50 facing the substrate 10 are already hydrophilized to have the water layers 52.

As shown in FIG. 1, in a state that the substrate 100 is pressed against the holding surface 106c of the vacuum chuck 106 from below, a vacuum state is created in the inner space 106d to vacuum-adsorb the substrate 10 onto the holding surface 106c, thereby securely fixing the substrate 10 to the holding surface 106c. Alternatively, the substrate 10 is mounted on the holding surface 106c of the vacuum chuck 106 which faces upward, and is then vacuum-adsorbed and securely fixed to the support surface 106c by creating a vacuum state in the inner space 106d. Thereafter, the vacuum chuck 106 is turned upside down.

After the infrared lamp 105 is turned on to emit infrared lights, overlapping states of the chips 50 and the contact regions 11 of the substrate 10 are photographed with the CCD camera 107 by using the infrared lights penetrating the tray 200, the substrate 10 and the vacuum chuck 106. While photographing the states with the CCD camera 107, the control stage 102 is first switched to the rough operation mode, and then the positions of the contact regions 11 of the substrate 10 are roughly matched with the positions of the chips 50 on the tray 200. Then, the control stage 102 is switched to the fine operation mode to minutely adjust the positions, thereby completing the alignment of the contact regions 11 of the substrate 10 with the chips 50 on the tray 200.

Next, the contact process is carried out in step S16. In step S16, the substrate 10 and the tray 200 are brought close to each other, and accordingly the water layers 52 and the contact regions 11 on the surface of the substrate 10 come into contact with each other. FIG. 3F shows the state of the chips and the substrate in step S16.

As shown in FIG. 3F, the tray 200 and the substrate 10 are disposed to face each other and brought close to each other. Here, the shortest distance between the chips 50 and the substrate 10 is set to, for example, 500 μm. Then, the water layers 52 formed on the joint portions 51 on the surfaces of the chips 50 come in contact with the contact regions 11 on the surface of the substrate 10.

Since the contact regions 11 on the surface of the substrate 10 are hydrophilized, the water layers 52 spread to and wet the entire portion of each of the contact regions 11. The chips 50 are moved as the joint portions 51 are adsorbed to the contact regions 11 by the surface tension of water in the water layers 52. As a result, the respective chips 50 are adsorbed onto the corresponding contact regions 11 via the water layers 52, which is shown in FIG. 3F. That is, an adsorption is generated between the water layers 52 and the chips 50 and between the water layers 52 and the substrate 10, and thus the chips 50 are adsorbed to the substrate 10 via the water layers 52. At this time, the chips 50 and the contact regions 11 are self-aligned by the surface tension of water. That is, water also serves to perform alignment in the present invention. Then, the chips 50 float and are separated from the tray 200.

Next, the separation process is carried out in step S17. In step S17, the substrate 10 and the tray 200 are spaced away from each other. FIGS. 5 and 3G show the state of the chips and the substrate in step S17.

As shown in FIGS. 5 and 3G, the substrate 10 is moved upwards. At this time, the substrate 10 becomes spaced away from the tray 200 in a state that the chips 50 are adsorbed onto the contact regions 11 via the water layers 52.

Next, the depressurization process is carried out in step S18. In step S18, the processing chamber 101 is depressurized. FIG. 3H shows the state of the chips and the substrate in step S18. Step S18 corresponds to a fixing process in the present invention.

When the processing chamber 101 is slightly depressurized, water remaining between the joint portions 51 of the chips 50 and the corresponding contact regions 11 is gradually evaporated. As a result, the joint portions 51 are closely attached to the corresponding contact regions 11, and the chips 50 are securely fixed and preliminarily joined to the substrate 10, as shown in FIG. 3H.

Then, the heating process is carried out in S19. In step S19, the substrate 10 to which the chips 50 has been preliminarily joined is heated. FIG. 3I shows the state of the chips and the substrate in step S19. Step S19 also corresponds to the fixing process in the present invention.

In the meantime, the chips 50 may be dislocated from the corresponding contact regions 11 when the substrate 10 is upside down after step S18 is conducted. Thus, as shown in FIG. 3I, the substrate 10 is moved from the processing chamber 101, for example, to a heating furnace 150 to be heated. The substrate 10 is heated, for example, in a range from about 90 to 100° C., thereby completely evaporating the water. That is, the water layers 52 are removed. Accordingly, the chips 50 and the substrate 10 preliminarily joined are securely joined.

Alternatively, the substrate 10 may be heated in the processing chamber 101 by providing a heater in, e.g., the vacuum chuck 106 without having to be moved to the heating furnace. In this case, steps S18 and S19 may be carried out at the same time. Alternatively, step S19 may be omitted depending on the extent of the joining force of the chips 50 to the substrate 10.

As shown in FIG. 6, the chips 50 and the substrate 10 may also be joined by pushing a pressing plate 180 to the substrate 10 to which the chips 50 has been preliminarily joined. In this case, the tray 200 is detached from the support base (tray supporting unit) 104, and the pressing plate 180 is attached thereto instead. Then, by moving the control arm 103 downwards or the control stage 102 upwards, the chips 50 preliminarily joined to the contact regions 11 are pushed to the lower surface of the pressing plate 180. Accordingly, the joint portions 51 of the chips 50 and the contact regions 11 are further closely attached to each other.

Next, the turn-over process is carried out in step S20. In step S20, the substrate 10 to which the chips 50 has been joined is turned over. FIG. 3J shows the state of the chips and the substrate in step S20.

In step S20, the substrate 10 is turned over as shown in FIG. 3J after the chips 50 and the substrate 10 are completely joined in steps S18 and S19.

After the chips 50 are joined to the contact regions 11, air is introduced into the inner surface 106d of the vacuum chuck 106, and then the substrate 10 is separated from the vacuum chuck 106. Subsequently, the substrate 10 on which the chips 50 are mounted is moved to a device for performing a joining process, the device being integrated with or separated from the mounting device 100, and electrically/mechanically connected to the mounting surface of a support substrate or a corresponding semiconductor circuit layer by using a micro-bump electrode.

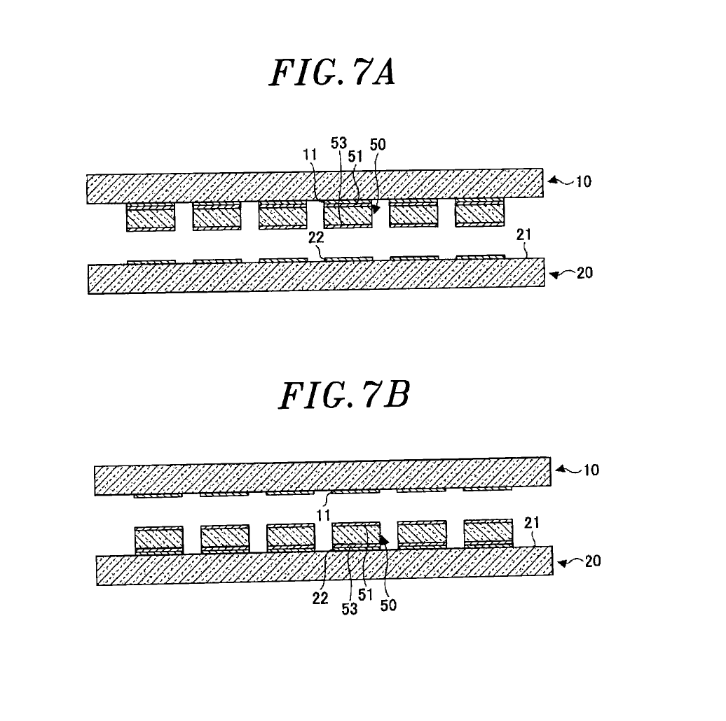

In the present embodiment, the foregoing substrate (hereinafter, referred to as a first substrate) 10 may be a preliminary transfer substrate, i.e., a carrier substrate, for transferring (mounting and moving) chips onto a substrate on which the chips are to be mounted not a substrate on which the chips are to be mounted. Hereinafter, a method of transferring (mounting and moving) chips from the first substrate 10 as the carrier substrate to a chip mounting substrate (hereinafter, referred to as a second substrate) 20 will be described with reference to FIGS. 7A and 7B.

FIGS. 7A and 7B are schematic cross-sectional views illustrating the state of the chips and the substrate when the chips are transferred (mounted and moved) from the first substrate to the second substrate.

As shown in FIG. 7A, the first substrate 10 as the carrier substrate to which all needed chips 50 are preliminarily joined is moved down parallel to the second substrate 20 as a support substrate, which is maintained horizontally with the mounting surface 21 facing upwards, thereby bringing the connecting members 53 formed on the surfaces of the chips 50 in contact with corresponding connecting members 22 of the second substrate 20 at one time. Alternatively, the second substrate 20 is raised parallel to the first substrate 10, thereby bringing the connecting members 53 in contact with the connecting members 22 at one time. Thereafter, the connecting members 53 of the chips 50 are fixed to the corresponding connecting members 22 on the second substrate 20 by a proper method. For example, a method of joining micro-bump electrodes with a connection metal placed therebetween may be used. Alternatively, the micro-bump electrodes are joined by pressure welding or welding without an interposed connection metal.

After the connecting members 53 and 22 are fixed, a force is applied in a direction to separate the first substrate 10 from the chips 50. Then, as shown in FIG. 7B, the joint portions 51 of the chips 50 are easily separated from the contact regions 11 of the first substrate 10 in a state that the chips 50 are joined to the second substrate 20. Thereafter, a liquid or fluidic adhesive is provided in gaps around the chips 50 and cured by, e.g., heating or ultraviolet irradiation, thereby securely fixing the chips 50 to the second substrate 20.

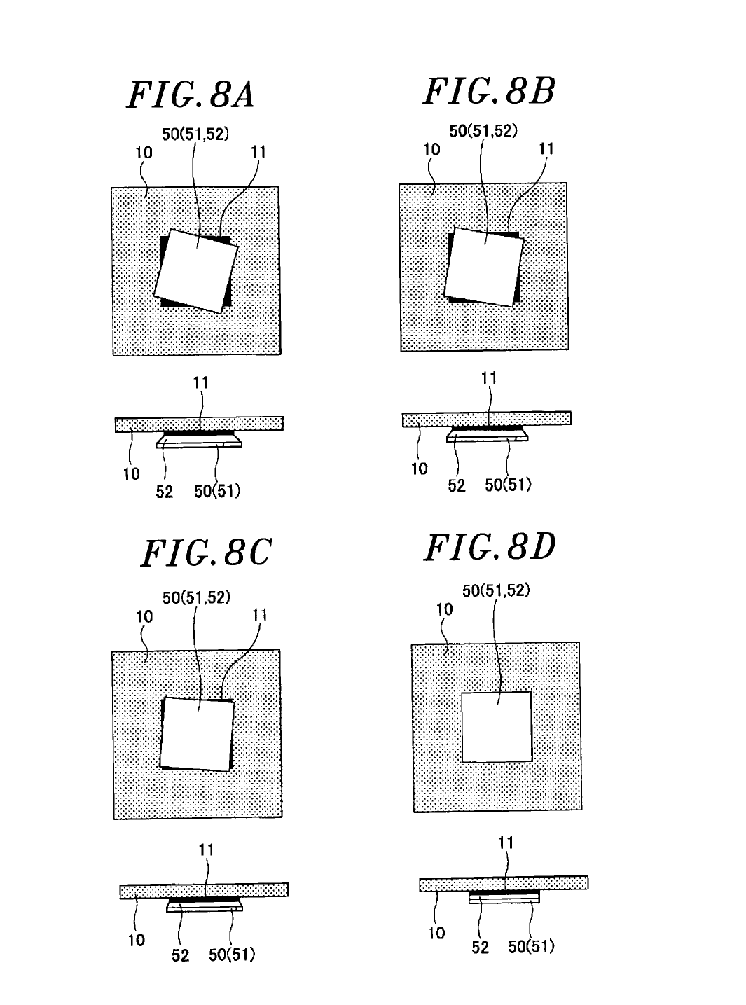

Hereinafter, the self-alignment of the chips with the substrate performed by a liquid in accordance with the mounting method of the first embodiment will be described with reference to FIGS. 8A to 10B.

FIGS. 8A to 8D are plan views and cross-sectional views showing how the state of a chip is changed from the state of being brought into contact with the surface of water while being obliquely misaligned with the contact regions to the state of being mounted on proper positions by self-alignment. FIGS. 8A to 8D show the change over time, wherein the upper section illustrates plan views seen from below and the lower section illustrates cross-sectional views.

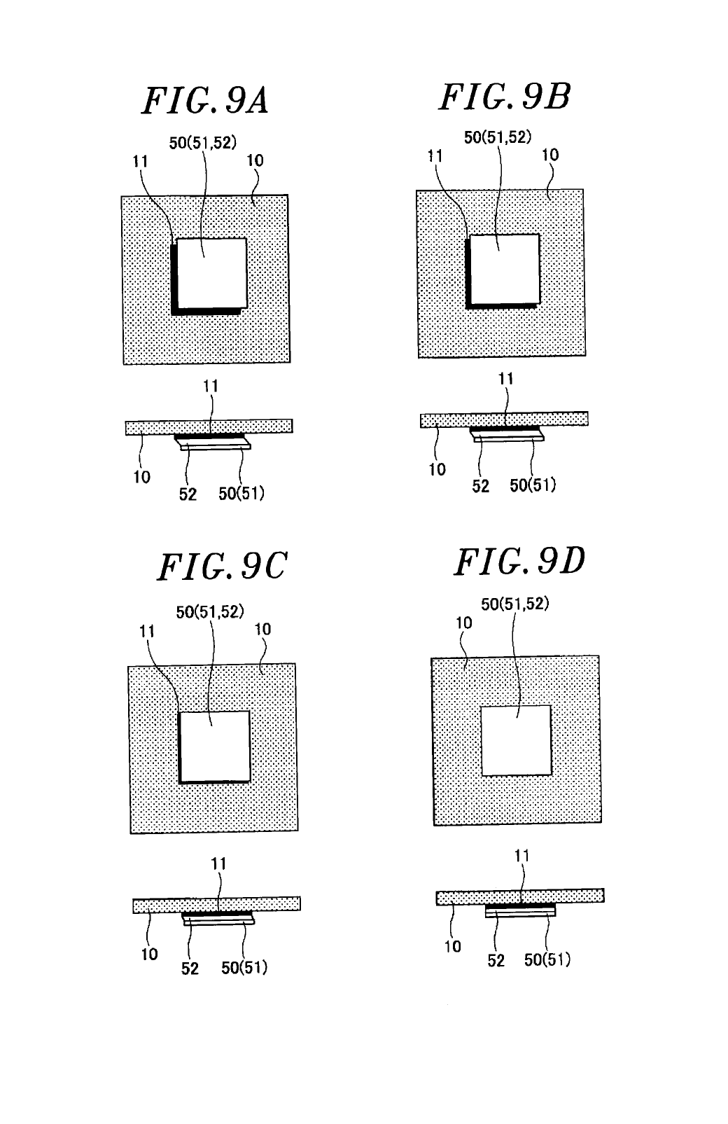

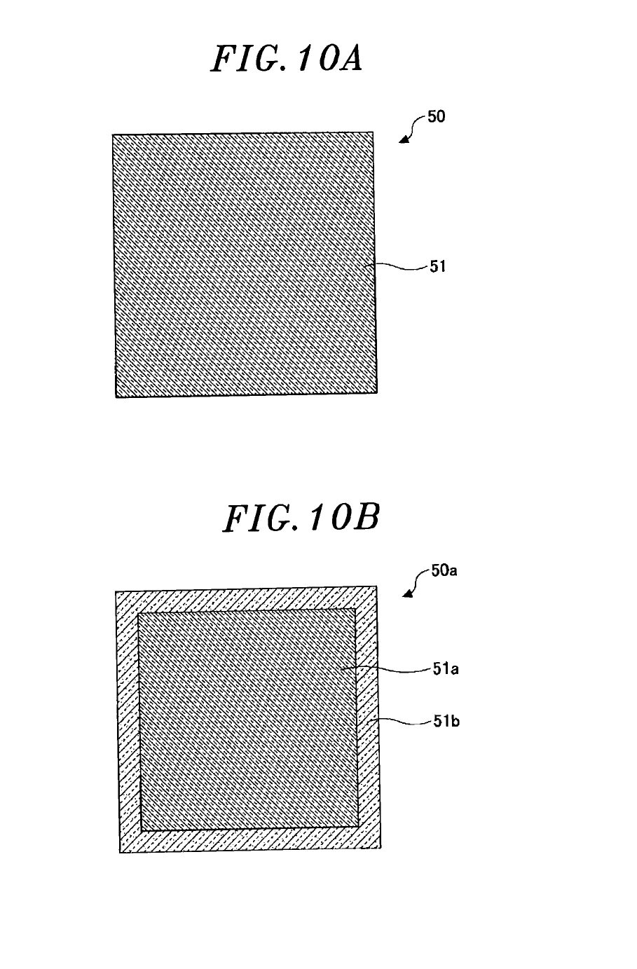

FIGS. 9A to 9D are plan views and cross-sectional views showing how the state of a chip is changed from the state of being brought into contact with the surface of water while being horizontally misaligned with the contact regions to the state of being mounted on proper positions by self-alignment. FIGS. 9A to 9D show the change over time, wherein the upper section illustrates plan views seen from below and the lower section illustrates cross-sectional views. FIGS. 8A to 9D show merely a portion of the substrate 10 around the contact regions 11. FIGS. 10A and 10B are plan views illustrating the hydrophilized region on the surfaces of the chips.

In a state that the joint portions 51 of the chips 50 are brought into contact with the contact regions 11 of the substrate 10 while being obliquely misaligned therewith, water from the water layers 52 formed on the joint portions spreads to and wet the contact regions 11 that are subjected to the hydrophilization process, as shown in FIG. 8A. Then, with the surface tension of water, the chips 50 are rotated from FIG. 8B to FIG. 8C, narrowing the gap between the joint portions 51 and the contact regions 11 in such a way that the joint portions 51 and the contact regions 11, which are designed to have the same size, substantially entirely overlap with each other. Finally, the joint portions 51 of the chips 50 substantially entirely overlap with the contact regions 11 of the substrate 10, as shown in FIG. 8D.

Meanwhile, when the joint portions 51 of the chips 50 are brought into contact with the contact regions 11 of the substrate 10 while being horizontally misaligned therewith, water from the water layers 52 formed on the joint portions spreads to and wet the contact regions 11 that are subjected to the hydrophilization process, as shown in FIG. 9A. Then, with the surface tension of water, the chips 50 are moved horizontally from FIG. 9B to FIG. 9C, narrowing the gap between the joint portions 51 and the contact regions 11 in such a way that the joint portions 51 and the contact regions 11, which are designed to have the same size, substantially entirely overlap with each other. Finally, the joint portions 51 of the chips 50 substantially entirely overlap with the contact regions 11 of the substrate 10, as shown in FIG. 9D.

As shown in FIG. 10A, since the entire surface of each of the chips 50 are generally hydrophilized as the joint portions 51, the surface of the edge region of the chips 50 is also hydrophilized. However, as shown in FIG. 10B, chips 50a may have a center region defined as joint portions 51a and a non-hydrophilized edge region defined as hydrophobic portions (hydrophobic frame) 51b. By providing the hydrophobic frame 51b on the edge region of the chips 50a, the position alignment can be realized by using the boundary shape between the joint portions 51a and the hydrophobic frame 51b. Thus, even though the chips have an undesired shape of edge portions due to a burr involved in dicing the chips into individual pieces, if the shape of the joint portions 51a in the center region is maintained properly, the chips are aligned with the contact regions by water at high accuracy.

Although there is no particular limitation as to a method of forming the hydrophobic frame 51b, the hydrophobic frame 51b may be formed such that the surfaces of the joint portions 51a are formed of, e.g., a SiO₂ film having hydrophilicity and the surface of the hydrophobic frame 51b is formed of, e.g., Si.

As described above, in accordance with the present embodiment, a tray on which chips are mounted without vacuum adsorption is moved close to a substrate disposed above the tray and water coated on the surface of the chips comes in contact with the surface of the substrate, thereby adsorbing the chips to the substrate via the water. Since the chips are moved in a state of being strongly adsorbed to the substrate via water, it is not possible that the chips drop during the processes. Further, the chips and the substrate are self-aligned with each other by water. Thus, an element, such as a chip, is securely mounted on the substrate without involving an increase in device costs.

### Modification of First Embodiment

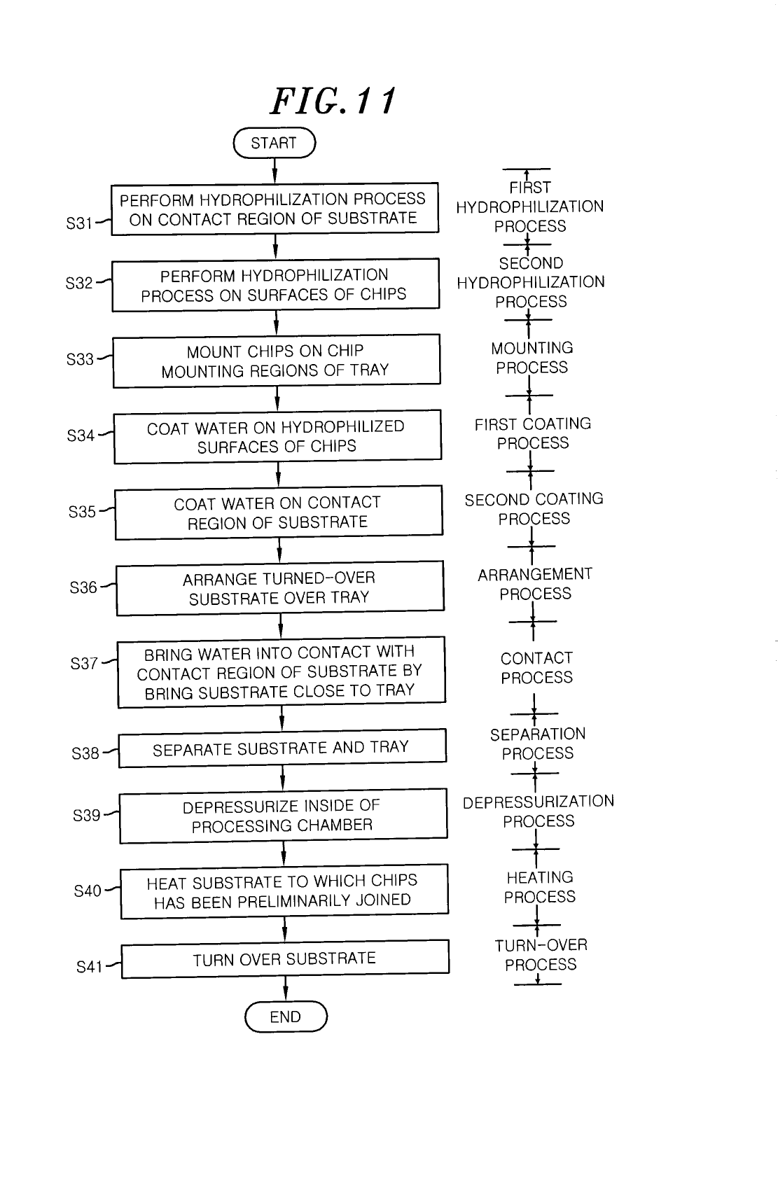

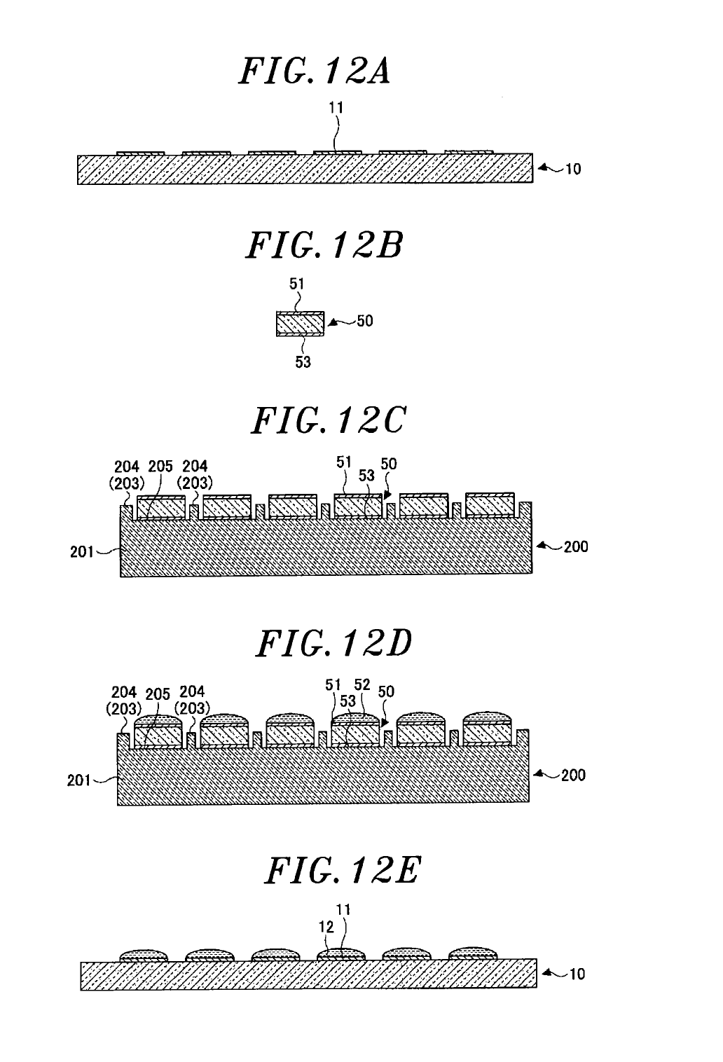

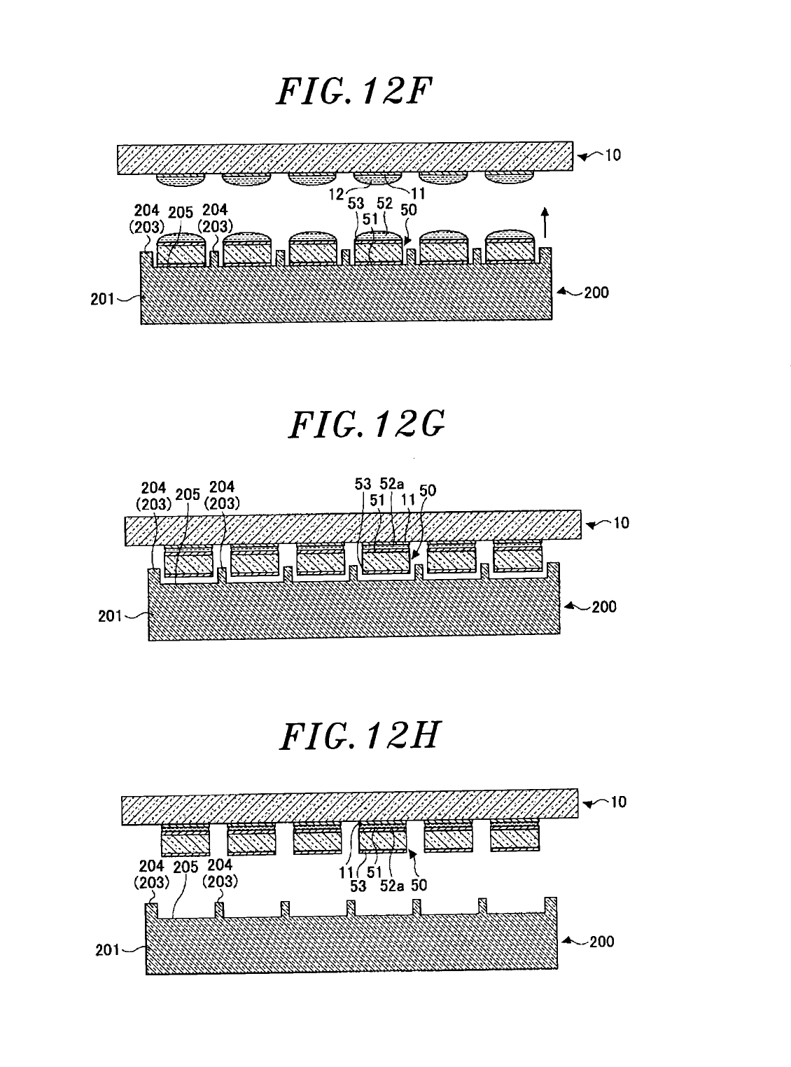

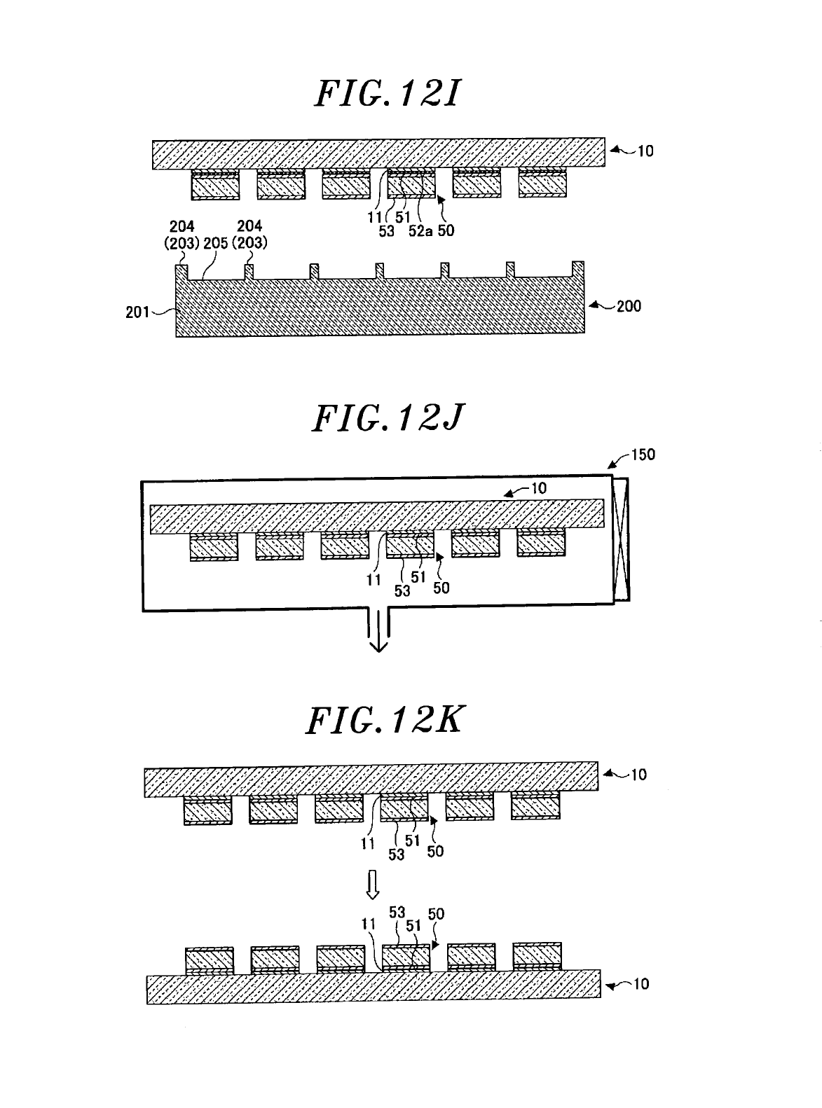

Next, a mounting method in accordance with a modification of the first embodiment will be described with reference to FIGS. 11 to 12K.

FIG. 11 is a flowchart illustrating the processes of the mounting method in accordance with the modification of the first embodiment. FIGS. 12A to 12K are schematic cross-sectional views illustrating the state of chips and a substrate in the respective process of the mounting method in accordance with the modification. Throughout the following embodiments, like reference numerals will be given to like parts, and redundant description thereof will be omitted.

The mounting method in accordance with the modification is different from the mounting method in accordance with the first embodiment in that water is coated on a contact region of a substrate hydrophilized.

The mounting method in accordance with the modification is carried out by the mounting device in accordance with the first embodiment.

As shown in FIG. 11, the mounting method in accordance with the modification includes a first hydrophilization process (step S31), a second hydrophilization process (step S32), a mounting process (step S33), a first coating process (step S34), a second coating process (step S35), an arrangement process (step S36), a contact process (step S37), a separation process (step S38), a depressurization process (step S39), a heating process (step S40), and a turn-over process (step S41).

First, steps S31 to S34 are carried out. Steps S31 to S34 may be carried out in the same manner as in steps S11 to S14. Here, the first coating process in step S34 is the same as the coating process in step S14. That is, the first coating process corresponds to the coating process in the present invention. FIGS. 12A to 12D showing the state of the chips and the substrate in steps S31 to S34 are the same as FIGS. 3A to 3D.

Next, the second coating process is carried out in step S35. In step S35, water is coated on the contact regions 11 on the hydrophilized surface of the substrate 10 to which the chips 50 are to be joined. FIG. 12E shows the state of the substrate in step S35.

A small amount of water is dropped on the contact regions 11 or the substrate 10 is dipped in water, thereby wetting the contact regions 11. Then, as shown in FIG. 12E, the water spreads to the entire surfaces of the contact regions 11 with the hydrophilicity of the contact regions 11, so that thin water layers 12 covering the entire surfaces of the contact regions 11 are formed. The water layers 12 curve naturally in a gentle convex form by surface tension. The amount of water is preferably adjusted to, for example, the extent enough to form the water layers 12 on the contact regions 11 as shown in FIG. 12E.

Step S35 may be carried out after step S36. If step S35 is conducted after step S36, the substrate 10 is held by the vacuum chuck 106 with the contact regions 11 facing downwards, and then pure water is spouted to the substrate 10 from below, thereby forming the water layers 12 on the contact regions 11.

Next, the arrangement process is carried out in step S36. Step S36 is conducted in the same manner as in step S15 of the first embodiment. FIG. 12F showing the state of the chips and the substrate in step S36 is the same as FIG. 3E.

Then, the contact process is carried out in step S37. In step S37, the substrate 10 and a tray 200 are brought close to each other, so that the water layers 52 come into contact with the contact regions 11 on the surface of the substrate 10 via the water layers 12. FIG. 12G shows the state of the chips and the substrate in step S37.

As shown in FIG. 12G, the tray 200 and the substrate 10 are disposed to face each other and brought close to each other. Here, the shortest distance between the chips 50 and the substrate 10 is set to, for example, 500 μm. Then, the water layers 52 formed on the joint portions 51 on the surfaces of the chips 50 come in contact with the contact regions 11 on the surface of the substrate 10 via the water layers 12 formed on the contact regions 11.

The water layers 52 and the water layers 12 combine into water layers 52a. The chips 50 are moved in such a way that the joint portions 51 are adsorbed to the contact regions 11 by the surface tension of water in the water layers 52a. As a result, the respective chips 50 are adsorbed onto the corresponding contact regions 11 via the water layers 52a, which is shown in FIG. 12G. That is, an adsorption is generated between the water layers 52s and the chips 50 and between the water layers 52a and the substrate 10, and thus the chips 50 are adsorbed to the substrate 10 via the water layers 52s. At this time, the chips 50 and the contact regions 11 are self-aligned by the surface tension of water. Further, the chips 50 float and are separated from the tray 200.

Next, steps S38 to S41 are carried out. Steps S38 to S41 are carried out in the same as in step S17 to S20 in the first embodiment. FIGS. 12H to 12K showing the state of the chips and the substrate in steps S38 to S41 are the same as FIGS. 3G to 3J.

In accordance with the modification of the first embodiment, a tray on which chips are mounted without vacuum adsorption is moved close to a substrate disposed above the tray and water coated on the surfaces of the chips come in contact with water coated on the surface of the substrate, thereby adsorbing the chips to the substrate via the water.

Since the chips are moved in a state of being strongly adsorbed to the substrate via water, it is not possible that the chips drop during the processes. Further, the chips and the substrate are self-aligned with each other by water. Thus, an element, such as a chip, is securely mounted on the substrate without involving an increase in device costs.

### Second Embodiment

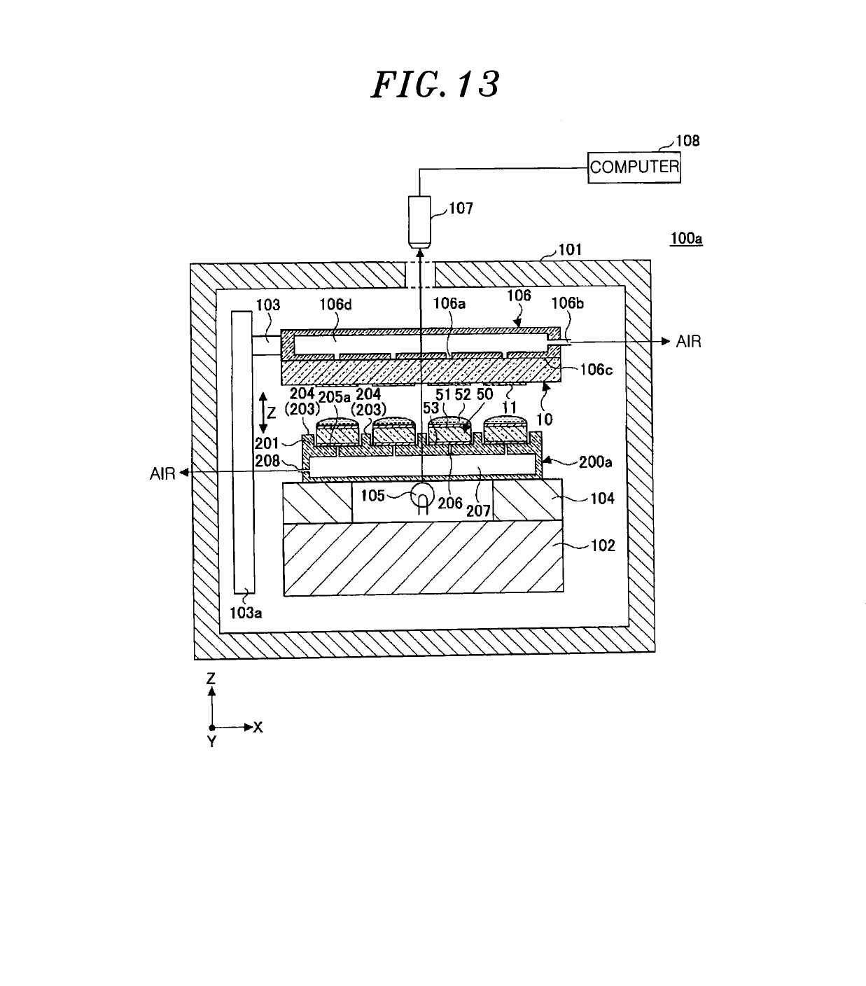

Hereinafter, a mounting method and a mounting device in accordance with a second embodiment of the present invention will be described with reference to FIGS. 13 to 15K.

The mounting device in accordance with the second embodiment is different from that of the first embodiment in that the mounting device uses a vacuum adsorption tray.

FIG. 13 is a schematic cross-sectional view illustrating a configuration of the mounting device in accordance with the second embodiment.

The mounting device 100a in accordance with the present embodiment includes a vacuum adsorption tray 200a.

The vacuum adsorption tray 200a includes a main body 201 having a rectangular plane shape. The main body 201 includes an inner space 207. The surface of an upper wall 203 of the main body 201 is partitioned into rectangular sections by partition walls 204, the rectangular sections serving as chip mounting regions 205. The chip mounting regions 205a are disposed inside external walls. Each of the chip mounting regions 205a includes a small hole 206 extending through the upper wall 203 to reach the inner space 208, wherein the hole 206 is formed nearly in the center of the chip mounting regions 205a.

A hole 208 communicating with the inner space 207 is provided in the bottom of the main body 201. Air in the inner space 207 is exhausted through the input and output hole 208 by using a vacuum pump, thereby creating a desirable vacuum state in the inner space 207. Accordingly, the chips 50 mounted in the chip mounting regions 205a are held by vacuum adsorption and separated from the chip mounting regions 205a by releasing vacuum adsorption.

Other aspects of the mounting device in accordance with the second embodiment than described above are the same as the mounting device of the first embodiment.

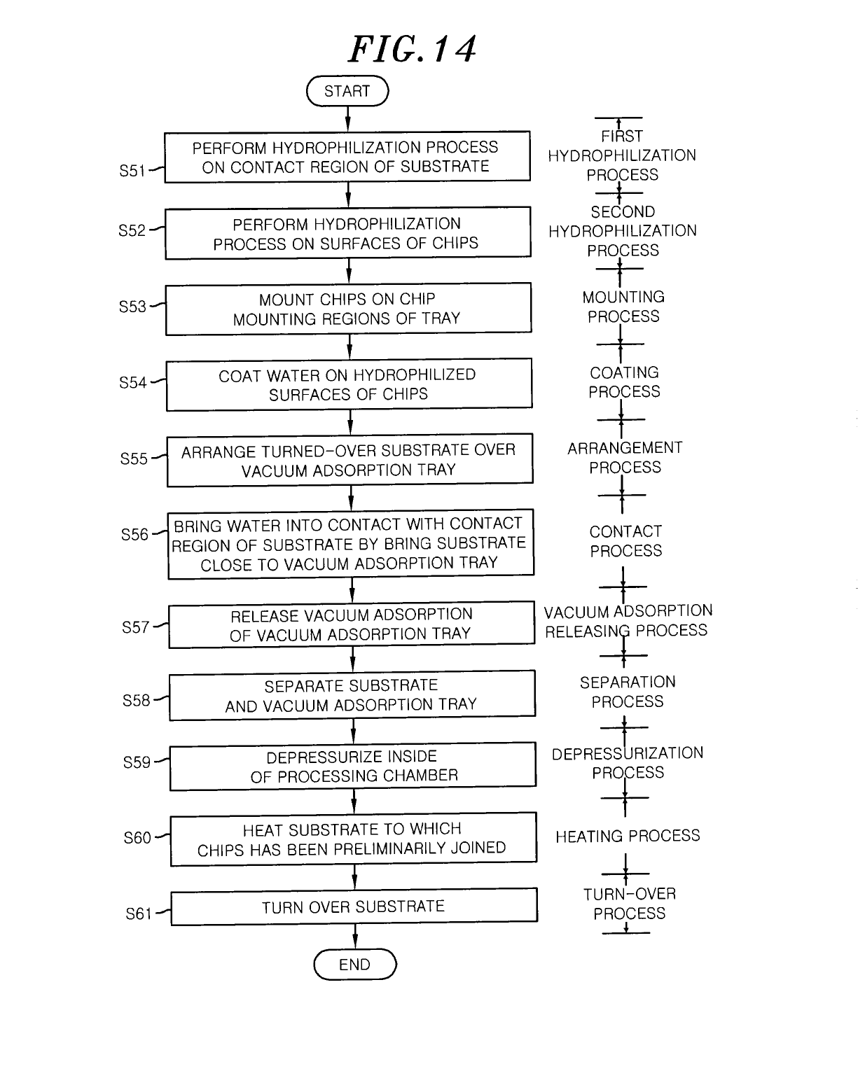

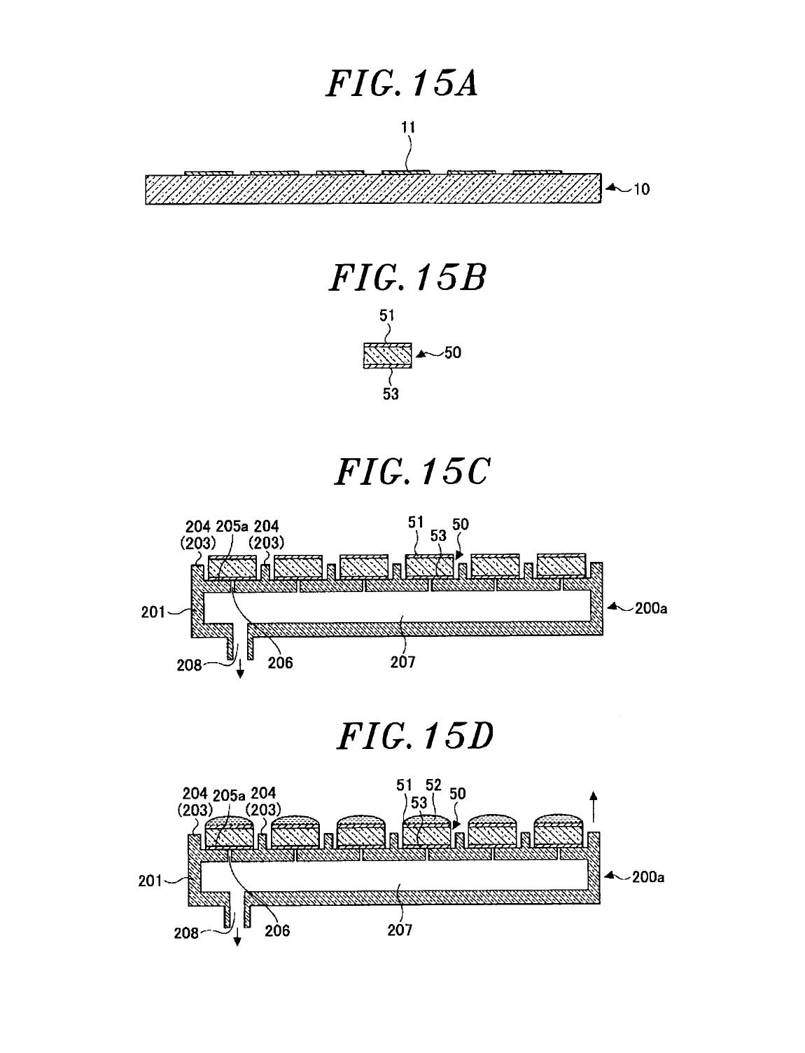

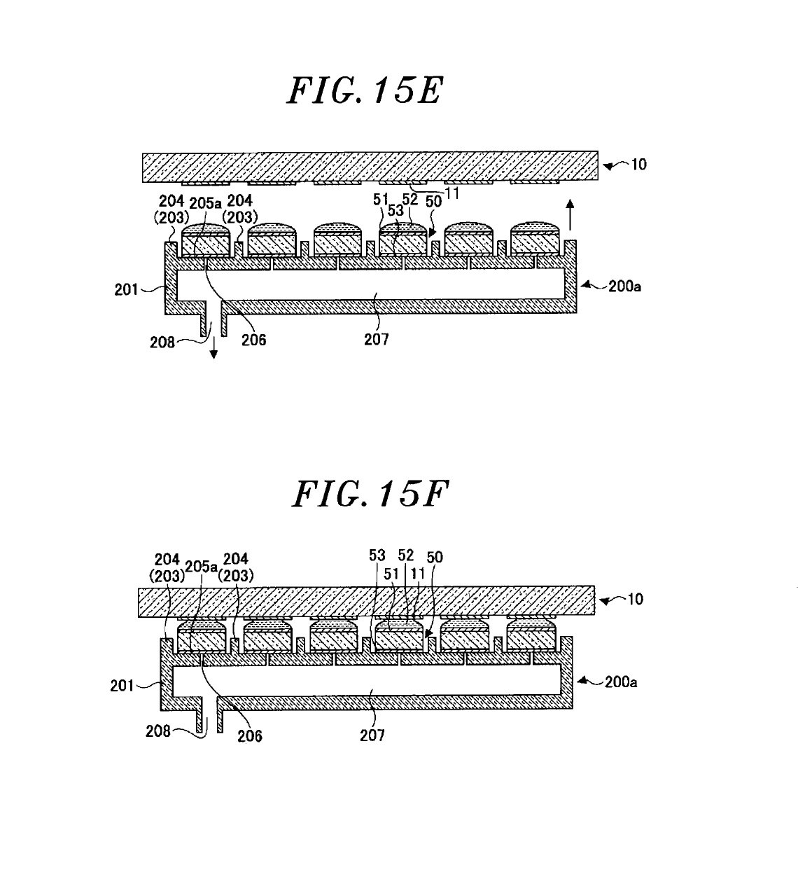

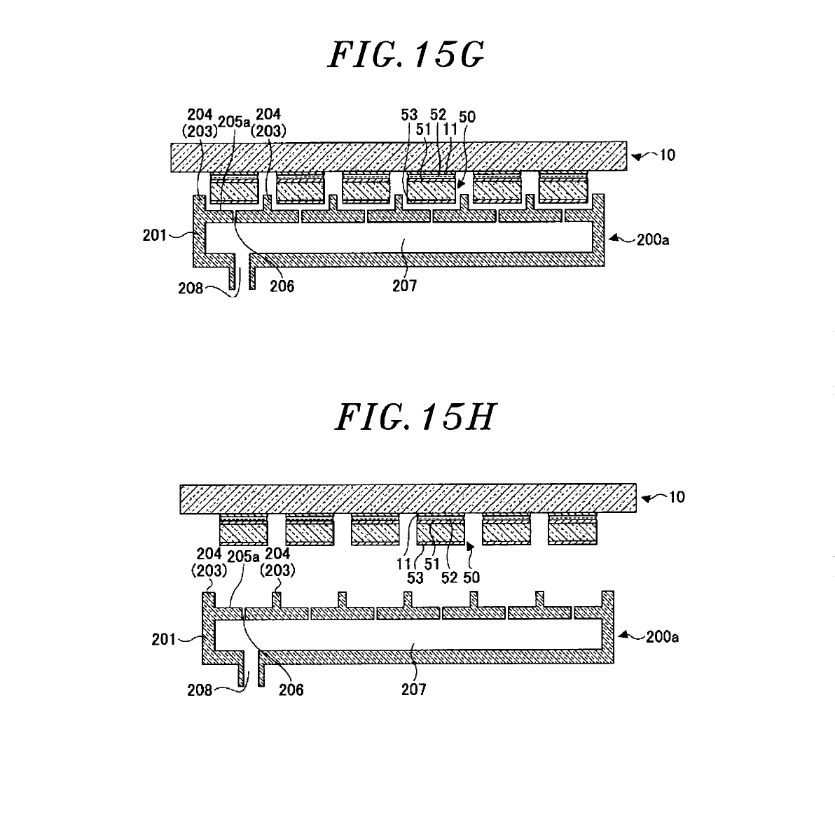

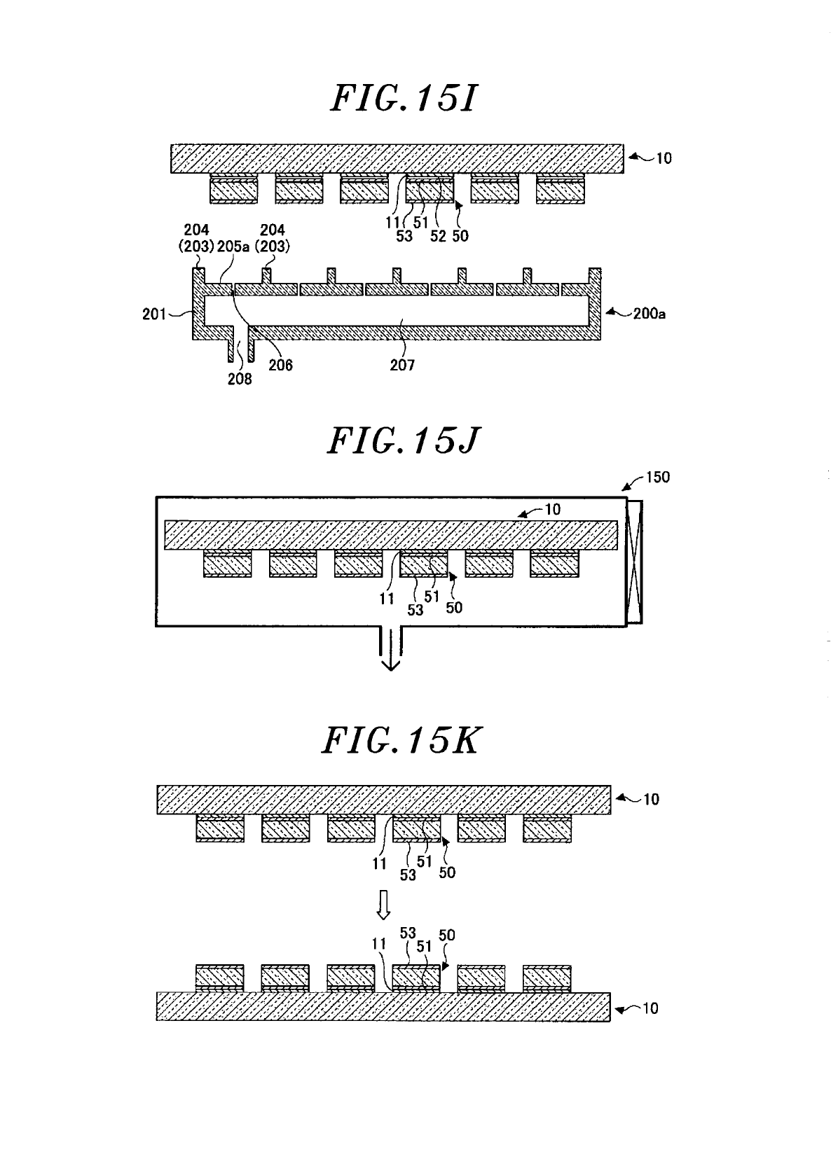

Next, the mounting method of the mounting device in accordance with the second embodiment will be described with reference to FIGS. 14 to 15K.

FIG. 14 is a flowchart illustrating the processes of the mounting method in accordance with the second embodiment. FIGS. 15A to 15K are schematic cross-sectional views showing the states of the chips and the substrate in the respective processes of the mounting method.

As shown in FIG. 14, the mounting method in accordance with the second embodiment includes a first hydrophilization process (step S51), a second hydrophilization process (step S52), a mounting process (step S53), a coating process (step S54), an arrangement process (step S55), a contact process (step S56), a vacuum adsorption releasing process (step S57), a separation process (step S58), a depressurization process (step S59), a heating process (step S60), and a turn-over process (step S61). The vacuum adsorption releasing process corresponds to the releasing process in the present invention.

First, steps S51 and S52 are carried out. Steps S51 and S52 are conducted in the same manner as in steps S11 and S12 of the first embodiment. FIGS. 15A and 15B showing the state of the chips and the substrate in steps S51 and S52 are the same as FIGS. 3A and 3B.

Next, the mounting process is carried out in step S53. In step S53, the chips 50 are mounted on and adsorbed onto the chip mounting regions 205a of the vacuum adsorption tray 200a with the hydrophilized surface facing upwards. FIG. 15C shows the state of the chips in step S53.

A needed number of chips 50 are mounted on the chip mounting regions 205 of the vacuum adsorption tray 200a which face upwards, wherein the joint portions 51 face upward. Then, air in the inner space 207 is exhausted through the input and output hole 208, thereby creating a vacuum state in the inner space 207. Then, the air around the chips 50 is exhausted through the small hole 206 and the inner space 207, and thus the chips 50 are adsorbed onto the corresponding chip mounting regions 205a. Accordingly, the chips 50 are mounted in predetermined positions on the vacuum adsorption tray 200a by vacuum adsorption.

The respective chip mounting regions 205a have a rectangular shape in the same manner as the chips 50 but are formed to be slightly larger than the external diameter of the chips 50 to facilitate the arrangement of the chips 50. Thus, gaps in a range from about 1 μm to several hundreds μm are generally formed between the chips 50 and the surrounding partition walls 204.

Next, steps S54 and S55 are carried out. Steps S54 and S55 are conducted in the same manner as in steps S14 and S15 of the first embodiment. FIGS. 15D and 15E showing the state of the chips and the substrate in steps S54 and S55 are the same as FIGS. 3D and 3E.

Next, the contact process is carried out in S56. In step S56, the substrate 10 and the vacuum adsorption tray 200a are moved close to each other, and accordingly the water layers 52 and the contact regions 11 on the surface of the substrate 10 come into contact with each other. FIG. 15F shows the state of the chips and the substrate in step S56.

As shown in FIG. 15F, the vacuum adsorption tray 200a and the substrate 10 are disposed to face each other and brought close to each other. Here, the shortest distance between the chips 50 and the substrate 10 is set to, for example, 500 μm. Then, the water layers 52 formed on the joint portions 51 on the surfaces of the chips 50 come in contact with the contact regions 11 on the surface of the substrate 10.

Since the contact regions 11 on the surface of the substrate 10 are hydrophilized, the water layers 52 spread to and wet the entire portion of each of the contact regions 11. Here, the chips 50 are vacuum-adsorbed onto the vacuum adsorption tray 200a and thus are not moved.

Next, the vacuum adsorption releasing process is carried out in step S57. In step S57, the vacuum adsorption of the vacuum adsorption tray is released. FIG. 15G shows the state of the chips and the substrate in step S57.

The vacuum adsorption of the chips 50 onto the vacuum adsorption tray 200a is released. Then, the respective chips 50 can be freely moved and are adsorbed to the contact regions 11 by the surface tension of water in the water layers 52. As a result, the respective chips 50 are adsorbed onto the corresponding contact regions 11 via the water layers 52, which is shown in FIG. 15G. That is, an adsorption is generated between the water layers 52 and the chips 50 and between the water layers 52 and the substrate 10, and thus the chips 50 are adsorbed to the substrate 10 via the water layers 52. Here, the chips 50 and the contact regions 11 are self-aligned by the surface tension of water. Then, the chips 50 float and are separated from the vacuum adsorption tray 200a.

Next, steps S58 to S61 are carried out. Steps S58 to S61 are conducted in the same manner as in steps S17 to S20 of the first embodiment. FIGS. 15H and 15K showing the state of the chips and the substrate in steps S58 to S61 are the same as FIGS. 3G and 3J.

In accordance with the present embodiment, a vacuum adsorption tray onto which chips are vacuum-adsorbed is moved close to a substrate disposed above the vacuum adsorption tray so that water applied to the surface of the chips comes in contact with the surface of the substrate. Then, the vacuum adsorption of the chips is released, thereby adsorbing the chips to the substrate via the water. Since the chips are moved in a state of being strongly adsorbed to the substrate via water, it is not possible that the chips drop during the processes.

In addition, since vacuum adsorption is not released until water comes into contact with the surface of the substrate, there is no possibility that the chips are dislocated from the vacuum adsorption tray by vibrations before the substrate is brought close to the vacuum adsorption tray. Further, the chips and the substrate are self-aligned with each other by water. Thus, an element, such as a chip, is securely mounted on the substrate without involving an increase in device costs.

The second embodiment may also include a second coating process of coating water to the contact regions of the substrate as in the modification of the first embodiment.

While the invention has been shown and described with respect to the embodiments, it will be understood by those skilled in the art that various changes and modifications may be made without departing from the scope of the invention as defined in the following claims.

This International application claims priority to Japanese Patent Application No. 2009-297627 filed on Dec. 28, 2009, the entire contents of which are incorporated herein by reference.

What is claimed is:

1. A mounting method of mounting an element on a substrate, the mounting method comprising:
a first hydrophilization process of hydrophilizing a region on a surface of the substrate where the element is to be joined;
a second hydrophilization process of hydrophilizing the surface of the element;
a mounting process of mounting the element on a mounting part in such a manner that the hydrophilized surface of the element faces upwards;
a first coating process of coating a liquid on the hydrophilized surface of the element;
an arrangement process of arranging the substrate above the mounting part in such a manner that the region on the surface of the substrate where the element is to be joined faces downwards; and
a contact process of bringing the substrate arranged above the mounting part and the mounting part on which the element is mounted close to each other to bring the liquid and the surface of the substrate into contact with each other.

2. The mounting method of claim 1, wherein the element is adsorbed onto the substrate via the liquid in the contact process.

3. The mounting method of claim 1, wherein the element is separated from the mounting part in the contact process.

4. The mounting method of claim 1, wherein the element is held by the mounting part by vacuum adsorption in the mounting process, and the method further comprises a releasing process of separating the element from the mounting part by releasing vacuum adsorption of the mounting part after the contact process.

5. The mounting method of claim 1, wherein the element and the substrate are aligned by the liquid in the contact process.

6. The mounting method of claim 1, further comprising a fixing process of evaporating the liquid and fixing the element to the substrate after the contact process.

7. The mounting method of claim 1, further comprising a second coating process of coating a liquid on the hydrophilized region on the surface of the substrate where the element is to be joined.

8. The mounting method of claim 1, wherein the liquid is water.

9. The mounting method of claim 7, wherein the liquid is water.

10. A mounting device for mounting an element on a substrate, the mounting device comprising:
a mounting part on which an element is mounted, the element being prepared by hydrophilizing the surface of the element and coating a liquid on the hydrophilized surface of the element, in such a way that the hydrophilized surface faces upwards;
a substrate holding unit disposed above the mounting part, the substrate holding unit serving to hold a substrate, the substrate being prepared by hydrophilizing a region on the surface of the substrate where the element is to be joined, in such a way that the region where the element is to be joined faces downwards; and
a control stage configured to move at least one of the substrate holding unit and the mounting part to bring the substrate holding unit holding the substrate and the mounting part on which the element is mounted close to each other, thereby bringing the liquid and the surface of the substrate into contact with each other.

11. The mounting device of 10, further comprising a position alignment mechanism to perform the position alignment of the substrate held by the substrate holding unit and the element mounted on the mounting part.

12. The mounting device of 10, wherein the control stage adsorbs the element onto the substrate via the liquid.

13. The mounting device of 10, wherein the control stage separates the element from the mounting part.

14. The mounting device of 10, wherein the element is maintained in the mounting part by vacuum adsorption and is separated from the mounting part by releasing vacuum adsorption after the liquid comes into contact with the surface of the substrate.

15. The mounting device of 11, wherein the position alignment mechanism performs the position alignment of the element and the substrate by the liquid.

16. The mounting device of 10, further comprising a processing chamber which is provided to surround the mounting part and the substrate holding unit and capable of depressurizing the inside thereof, and
the processing chamber depressurizes the inside to evaporate the liquid, thereby fixing the element to the substrate after the liquid comes into contact with the surface of the substrate.

17. The mounting device of 10, wherein the substrate holding unit holds the substrate in which a liquid is coated on the hydrophilized region on the surface of the substrate where the element is to be joined.

18. The mounting method of claim 10, wherein the liquid is water.

19. The mounting method of claim 17, wherein the liquid is water.
